(19) United States
(12) Patent Application Publication
(10) Pub. No.: US 2009/0116655 A1
(43) Pub. Date: May 7, 2009

(54) Adaptive filter calculation method and sound field generating device

(75) Inventors: Keiichiroh Tanaka, Kobe-shi (JP); Isao Wakabayashi, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, Kobe-shi (JP)

(21) Appl. No.: 12/289,843

(22) Filed: Nov. 5, 2008

(30) Foreign Application Priority Data
Nov. 6, 2007 (JP) 2007-288581

(51) Int. Cl. H04R 29/00

(52) U.S. Cl. 381/58

(57) ABSTRACT

For an inverse system including an adaptive filter having an inverse characteristic of a reproduction sound field characteristic and arranged in series with a stage previous to an output stage of the reproduction sound field characteristic, and an auxiliary filter for updating the adaptive filter arranged in parallel with an output stage of an arbitrary sound field characteristic, the auxiliary filter is identified based on the arbitrary sound field characteristic as a target using the adaptive filter with an initial value set therein or the adaptive filter having been updated. The adaptive filter is updated using the auxiliary filter thus identified. When update of the adaptive filter satisfied a predetermined end condition, the adaptive filter thus updated is superposed on the reproduction sound field characteristic.

### BACKGROUND OF THE INVENTION

1. Field of the Invention

The present invention relates to an adaptive filter calculation method and a sound field generating device.

2. Description of the Related Art

Recently, reproduction of highly realistic sound field (space where a sound wave is present) by a device such as a home theater system has been required. Such a device convolutes an impulse response in a space desired to be reproduced in sound to be reproduced (convolution: signal processing for adding characteristics,of signal B to signal A), thereby providing a realistic reproduction space.

When listening to music or the like reproduced by such a device, people hear sound with a combination of a sound field characteristic of a recording environment and a sound field characteristic of a reproduction environment. That is, a sound field characteristic of a room is superposed on the characteristic of a sound field to be reproduced. Therefore, an inverse system that negates the sound field characteristic of the reproduction environment has been proposed (for example, see Tazawa; Tsukamoto, Kajikawa, Nomura: “A Study on Sound Field Reproduction System Using the Simultaneous Perturbation Method”, Technical Report of IEICE, EA2005-8 (2005); Tsukamoto, Kajikawa, Nomura; “An Improving Method of Convergence Property of Sound Reproduction System Using the Perturbation Method with Delay Control”, Technical Report of IEICE, EA2006-09 (2006); Ito, Iwamatsu, Fujii, Muneyasu: “A consideration of multi-channel system identification algorithm”, Technical Report of IEICE, EA2006-98 (2007); and Fujii, Muneyasu; “A proposition of multi-channel system identification algorithm and its preventive condition of the increase of the estimation error”, Technical Report of IEICE, SIP2004-9 (2004)).

In the conventional technologies, as explained below, the sound cannot be reproduced appropriately. That is, at the time of convolution of an inverse filter by the inverse system, there is a need of taking into consideration a delay amount due to the convolution calculation and a delay amount present in the space. At this time, it is required to continuously increase the delay amount to be considered together with the convolution calculation, and the inverse filter is affected by the increased delay amount. As a result, the sound convoluted with the inverse filter (the sound supposed to be reproduced) exceeds a memory capacity, which causes a situation that there is no sound to be reproduced.

### SUMMARY OF THE INVENTION

It is an object of the present invention to at least partially solve the problems in the conventional technology.

According to an aspect of the present invention, there is provided an adaptive filter calculation method including: identifying an auxiliary filter for an inverse system including an adaptive filter that has an inverse characteristic of a reproduction sound field characteristic, which is a sound field characteristic of an environment where a sound source as an input signal is reproduced, and that is arranged in series with a stage previous to an output stage of the reproduction sound field characteristic, and the auxiliary filter that updates the adaptive filter and that is arranged in parallel with an output stage of an arbitrary sound field characteristic, wherein the auxiliary filter is identified based on the arbitrary sound field characteristic as a target using either the adaptive filter with an initial value set therein or the adaptive filter having been updated; and updating the adaptive filter using the auxiliary filter identified at the identifying.

According to another aspect of the present invention, there is provided a sound field generating device including: an identifying unit that identifies an auxiliary filter for an inverse system including an adaptive filter that has an inverse characteristic of a reproduction sound field characteristic, which is a sound field characteristic of an environment where a sound source as an input signal is reproduced, and that is arranged in series with a stage previous to an output stage of the reproduction sound field characteristic, and the auxiliary filter that updates the adaptive filter and that is arranged in parallel with an output stage of an arbitrary sound field characteristic, the identifying unit being configured to identify the auxiliary filter based on the arbitrary sound field characteristic as a target using either the adaptive filter with an initial value set therein or the adaptive filter having been updated; an updating unit that updates the adaptive filter using the auxiliary filter Identified by the identifying unit; and an adaptive-filter superposing unit that, when update of the adaptive filter satisfies a predetermined end condition, superposes the adaptive filter updated by the updating unit on the reproduction sound field characteristic.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an inverse system;

FIG. 2 depicts computational expressions for explaining each variable of the inverse system;

FIG. 3 is a block diagram of an inverse system including an auxiliary filter;

FIG. 4 depicts computational expressions for explaining each variable of the inverse system;

FIG. 5 depicts charts for explaining a problem associated with a delay amount;

FIG. 6 is a schematic diagram for explaining the outline and characteristics of an adaptive-filter calculating device according to a first embodiment of the present invention;

FIG. 7 is a block diagram of the adaptive-filter calculating device according to the first embodiment;

FIG. 8 depicts computational expressions in the adaptive-filter calculating device according to the first embodiment;

FIG. 9 is a flowchart of a process procedure performed by the adaptive-filter calculating device according to the first embodiment;

FIG. 10 depicts charts for explaining a simulation condition of a reproduction sound field characteristic (c);

FIG. 11 depicts charts for explaining a simulation condition of an arbitrary sound field characteristic (P);

FIG. 12 depicts charts for explaining a simulation condition of an adaptive filter (H);

FIG. 13 depicts charts for explaining a desired form of simulation;

FIG. 14 depicts charts for explaining a state before update;

FIG. 15 depicts charts for explaining first update;

FIG. 16 depicts charts for explaining second update;

FIG. 17 depicts charts for explaining third update;

FIGS. 18A and 18B are schematic diagrams for explaining the outline and characteristics of a sound field generating device according to a second embodiment of the present invention;

FIG. 19 is a block diagram of the sound field generating device according to the second embodiment; and

FIG. 20 is a flowchart of a process procedure performed by the sound field generating device according to the second embodiment.

### DETAILED DESCRIPTION OF THE PREFERRED EMBODIMENTS

Exemplary embodiments of the present invention will be explained in detail below with reference to the accompanying drawings. In the following, adaptive filter calculation method of the embodiments will be described as being applied to an adaptive-filter calculating device and a sound field generating device by way of example.

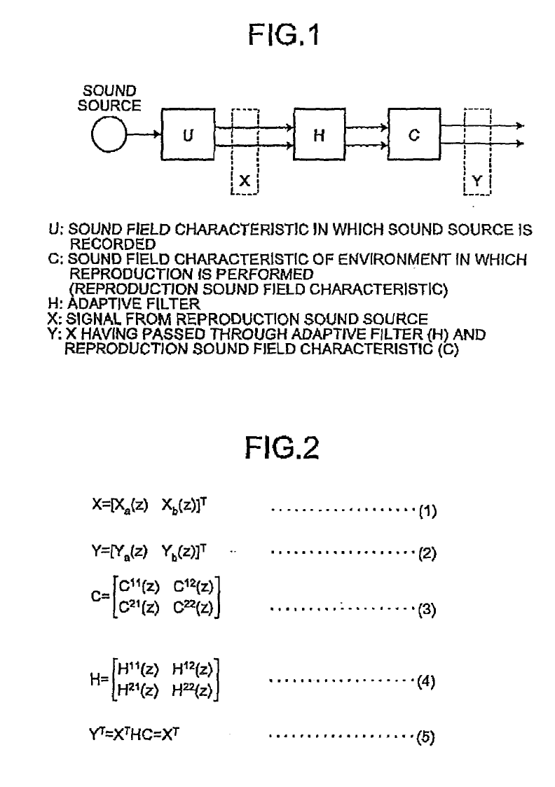

The term “inverse system” as used herein refers to an algorithm that negates a reproduction sound field characteristic (C), as shown in FIG. 1, when an output signal (Y) superposed with the reproduction sound field characteristic (C), which is a sound field characteristic of an environment where the sound source is reproduced, is output, designating a sound source having passed through a sound field characteristic (U) of a recording environment as an input signal (X). Specifically, in the “inverse system”, as shown in FIG. 1, an adaptive filter (H) having an inverse characteristic of the reproduction sound field characteristic (C) is serially incorporated in a previous stage of an output stage of the reproduction sound field characteristic (C).

For example, respective variables of the “inverse system” in a stereo environment are expressed by equations (1) to (4). It is understood that when equation (5) is established, the adaptive filter (H) can negate the reproduction sound field characteristic (C). That is, the adaptive filter (H) needs only to have the inverse characteristic of the reproduction sound field characteristic (C).

As shown in FIG. 1, because the adaptive filter (H) is serially incorporated in the previous stage of the output stage of the reproduction sound field characteristic (C), the adaptive filter (H) cannot be updated as it is, while assuming the reproduction sound field characteristic (C). That is, to update the adaptive filter (H), the reproduction sound field characteristic (C) needs to be assumed individually. Therefore, in the following embodiments, an auxiliary filter method is used.

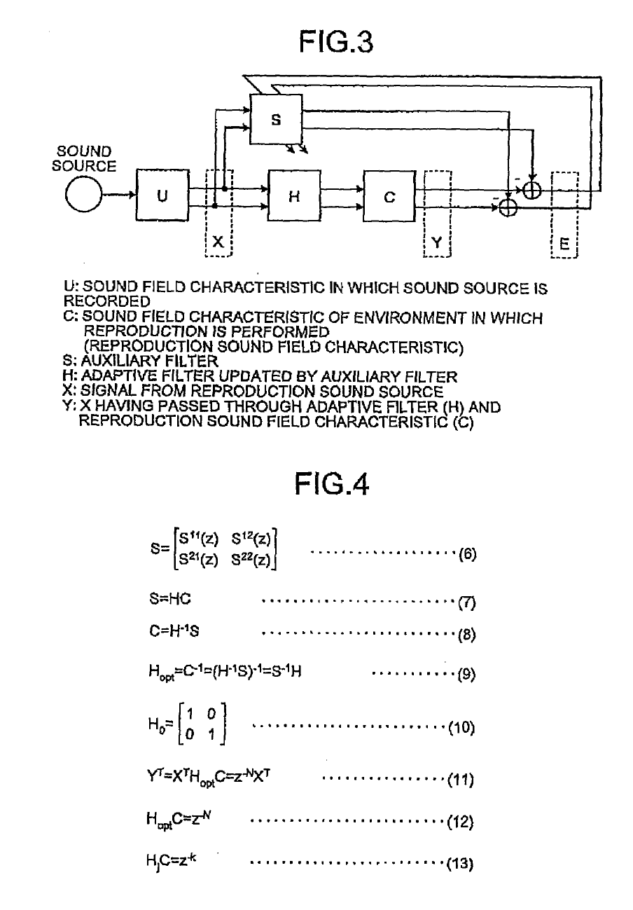

According to the auxiliary filter method, as shown in FIG. 3, in the “inverse system”, the adaptive filter (H) having the inverse characteristic of the reproduction sound field characteristic (C) is serially incorporated in the previous stage of the output stage of the reproduction sound field characteristic (C), and an auxiliary filter (S) for updating the adaptive filter (H) is incorporated in parallel. Thus, when the auxiliary filter (S) is introduced, it is not necessary to individually assume the reproduction sound field characteristic (C) for updating the adaptive filter (H).

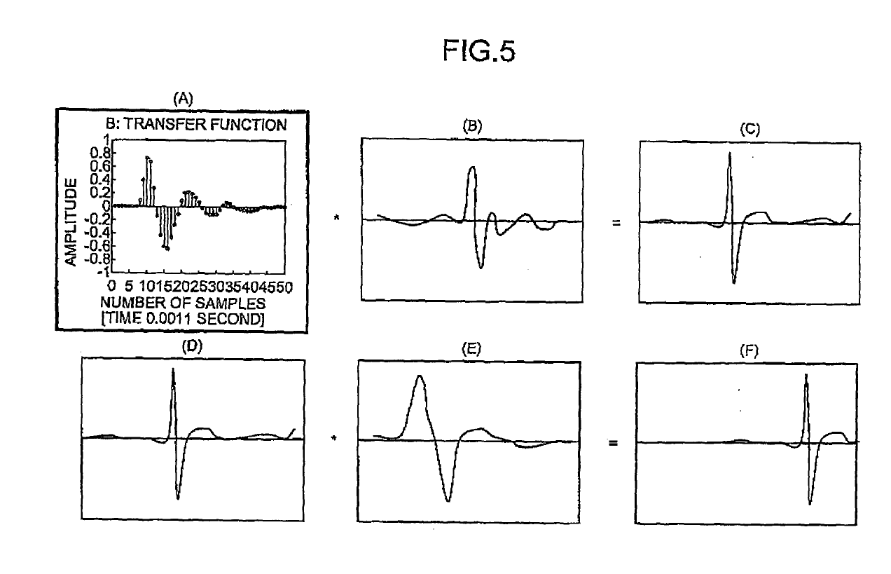

For example, the auxiliary filter (S) is expressed by equation (6) shown in FIG. 4. At this time, the auxiliary filter (S) is defined as shown in equation (7) shown in FIG. 4, and identified so that equation (7) is established. That is, the “inverse system” identifies the adaptive filter (H) so that an evaluation amount relating to an error (E) between the input signal (X) having passed through the adaptive filter (H) and the reproduction sound field characteristic (C) as a target and the input signal (X) having passed through the auxiliary filter (S) becomes the smallest. For example, the “inverse system” identifies the auxiliary filter (S) so that the error (E) becomes sufficiently small (becomes “0”):

When equation (7) shown in FIG. 4 is transformed, equation (8) is obtained (note a sequence to multiply a matrix), and considering that the adaptive filter (H) has the inverse characteristic of the reproduction sound field characteristic (C), after all, the adaptive filter (H) needs only to be updated according to equation (9). Further, as understood from equation (9), if the auxiliary filter (S) is sufficiently converged, the adaptive filter (H) is calculated algebraically.

Naturally, if an initial value of the adaptive filter (H) is “0”, the adaptive filter (H) will be never calculated. Therefore, the initial value of the adaptive filter (H) is Set as a unit matrix. For example, the initial value is set as shown in equation (10). By setting such an initial value, the input signal (X) is directly input to the reproduction sound field characteristic (C) in an initial stage. Further, by introducing the auxiliary filter (S), the adaptive filter (H) having the inverse characteristic of the reproduction sound field characteristic (C) can be obtained by one update of a coefficient. The inverse characteristic becomes an IIR type (infinite impulse responses).

The inverse system according to the auxiliary filter method has been explained so far with reference to FIG. 3 and the like. Considering that such an inverse system is applied to an actual system (actual environment), there are a delay amount due to the convolution calculation at the time of convoluting the adaptive filter (H) in the reproduction sound field characteristic (C) and a delay amount present in the space, it is essential to take these delay amounts into consideration. That is, in the actual system, the input signal (X) having passed through the adaptive filter (H) and the reproduction sound field characteristic (C) is affected by the delay without question. Therefore, the “inverse system” needs to determine or identify the auxiliary filter (S) so that the evaluation amount relating to the error (E) between the input signal (X) having passed through the adaptive filter (H) and the reproduction sound field characteristic (C) added with the delay amount as a target and the input signal (X) having passed through the auxiliary filter (S) becomes the smallest.

That is, if the adaptive filter (H) can completely assume the inverse characteristic, equation (5) in FIG. 2 becomes equation (11) in FIG. 4, and when equation (11) is transformed, equation (12) can be obtained. The right side of equation (12) indicates the delay amount, and means that when N=1, a delay by one sample is provided. However, it is very difficult to accurately obtain the delay amount. Therefore, the inverse system identifies the auxiliary filter (S) to achieve equation (13) shown in FIG. 4 as a target, by using a sufficiently large delay amount k (k>N). In other words, if the adaptive filter (H) can completely assume the inverse characteristic, the adaptive filter (H) and the reproduction sound field characteristic (C) negate each other, and the input signal (X) delayed by a provided delay amount k should be output. The inverse system identifies the auxiliary filter (S) so that the evaluation amount relating to the error (E) between the delayed input signal (X) as the target and the input signal (X) having passed through the auxiliary filter (S) becomes the smallest, and thereafter, updates the adaptive filter (H) by using the identified auxiliary filter (S). That is, the auxiliary filter (S) is identified to be converged to the delay amount k, and the adaptive filter (H) is updated by using the auxiliary filter (S) identified so as to be converged to the delay amount k.

In the actual system, however, the reproduction sound field characteristic (C) may fluctuate. Therefore, the inverse system needs to follow the fluctuation of the reproduction sound field characteristic (C) by repetitively executing the auxiliary filter method (or an equation-error approach). At this time, the above delay amount becomes a problem. That is, if there is a possibility that the reproduction sound field characteristic (C) fluctuates, the delay amount also changes. However, it cannot be predicted whether the delay amount increases or decreases. As described above, in equation (13), a sufficiently large delay amount k is set as the target. However, if it is tried to follow the fluctuation of the reproduction sound field characteristic (C), it is necessary to consider that the delay amount may increase, and after all, a delay amount larger than the previous delay amount needs to be set. If the reproduction sound field characteristic (C) does not fluctuate, the delay amount simply increases. However, because it cannot be predicted beforehand whether fluctuation of the reproduction sound field characteristic (C) occurs, the delay amount needs to be increased to follow the fluctuation. As a result, the delay amount continuously increases every time the inverse system updates the adaptive filter (H). That is, the auxiliary filter (S) is identified to converge to the continuously increasing delay amount, and the adaptive filter (H) is updated by using the auxiliary filter (S) identified to converge to the continuously increasing delay amount, and as a result, the adaptive filter (H) is affected by the increase of the delay amount.

This problem is illustrated in FIG. 5. In FIG. 5, (a) represents the input signal (X), (b) represents the adaptive filter (H), and (c) represents a signal in which the adaptive filter (H) is convoluted in the input signal (X). Besides, (d) represents a signal in which the adaptive filter (H) is convoluted in the input signal (X) as in (C) of FIG. 5, (e) represents the reproduction sound field characteristic (C), (f) represents an output signal (Y) in which the adaptive filter (H) and the reproduction sound field characteristic (C) are convoluted in the input signal (X).

When it is assumed that a horizontal width of a frame in FIG. 5 is a memory capacity, as indicated by (f) of FIG. 5, the output signal (Y) has already approached the right end of the frame due to an influence of the delay amount. If the adaptive filter (H) affected by a larger delay amount is convoluted in the next input signal (X), it is considered that the output signal (Y) further approaches the right end of the frame than in (f) of FIG. 5. When updating of the adaptive filter (H) is repeated in this manner, to repeat convolution of the adaptive filter (H) and the reproduction sound field characteristic (C), the output signal (Y) goes beyond the frame (exceeds the memory capacity) soon. This shows an event in which there is no sound to be reproduced.

Therefore, in practice, such a delay amount that exceeds the memory capacity cannot be set, and realization of the inverse system that follows the fluctuation of the reproduction sound field characteristic (C) becomes difficult the adaptive-filter calculating device of the first embodiment solves such a problem.

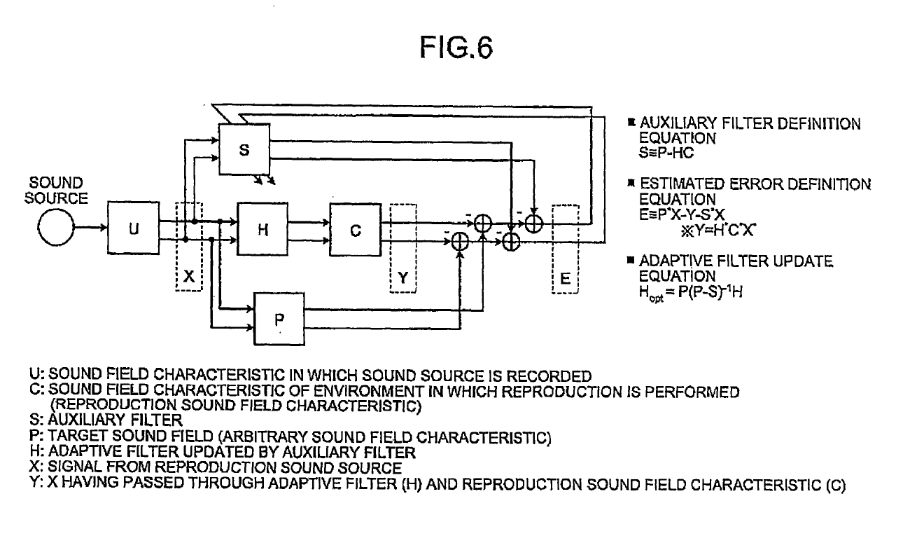

The outline and characteristics of the adaptive-filter calculating device according to the first embodiment will be described with reference to FIG. 6. FIG. 6 is a schematic diagram for explaining the outline and characteristics of the adaptive-filter calculating device according to the first embodiment.

The adaptive-filter calculating device of the first embodiment has an outline such that an adaptive filter is calculated with respect to the inverse system in which the adaptive filter having the inverse characteristic of the reproduction sound field characteristic, which is the sound field characteristic of an environment in which the sound source as an input signal is reproduced, is serially incorporated in the previous stage of the output stage of the reproduction sound field characteristic, and the auxiliary filter that updates the adaptive filter is incorporated in parallel, and the main characteristic thereof is to appropriately reproduce the sound.

Briefly explaining the main characteristic, in the inverse system in the first embodiment, as shown in FIG. 6, the output stage of arbitrary sound field characteristic (P) is further incorporated in parallel. In the first embodiment, a fixed value is provided to the arbitrary sound field characteristic (P) as a simple delay.

In such an inverse system, the auxiliary filter (S) is defined by a “auxiliary filter definition equation” shown in FIG. 6. In other words, as in an “estimated error definition equation” shown in FIG. 6, the error (E) is defined by an error obtained by subtracting the input signal (X) having passed through the adaptive filter (H) and the reproduction sound field characteristic (C) (“Y”) and the input signal (X) having passed through the auxiliary filter (S) (“S*X”) from the input signal (X) having passed through the arbitrary sound field characteristic (P) (“P*X”) as a target (“P*X-Y-S*X”). The adaptive-filter calculating device of the first embodiment identifies the auxiliary filter (S) so that the error (E) becomes “0”.

By transforming these equations, the adaptive-filter calculating device needs only to update the adaptive filter (H) according to an “adaptive filter update equation” in FIG. 6. That is, the adaptive-filter calculating device updates the arbitrary sound field characteristic (P) as a target, by updating the adaptive filter (H) by the update equation indicated by the arbitrary sound field characteristic (P) and the auxiliary filter (S) identified according to the arbitrary sound field characteristic (P) as a target.

Thus, the adaptive-filter calculating device of the first embodiment updates the adaptive filter (H) by using the arbitrary sound field characteristic (P), in which a fixed value is provided as the simple delay, as a target. Accordingly, the delay amount does not continuously increase every time the adaptive filter (H) is updated, thereby enabling to appropriately reproduce the sound.

It is considered as to how the adaptive-filter calculating device of the first embodiment solves the problem associated with the delay amount. In the actual system, the input signal (X) having passed through the adaptive filter (H) and the reproduction sound field characteristic (C) is affected by the delay without fail. Therefore, the delay amount is included in the input signal (X) having passed through the adaptive filter (H) and the reproduction sound field characteristic (C). On the other hand, the adaptive-filter calculating device of the first embodiment includes the delay amount by setting a fixed value to the arbitrary sound field characteristic (P) incorporated in parallel therewith as the simple delay.

Further, the arbitrary sound field characteristic (P) incorporated in parallel therewith is an arbitrary sound field characteristic, which becomes a target when the auxiliary filter (S) is identified. That is, the adaptive-filter calculating device updates the adaptive filter (H) so that the input signal (X) having passed through the adaptive filter (H) and the reproduction sound field characteristic (C) becomes equal to the input signal (X) having passed through the arbitrary sound field characteristic (P). In other words, the adaptive-filter calculating device identifies the auxiliary filter (S) in the “auxiliary filter definition equation” in FIG. 6 to be “0.”

It is assumed herein that “DP” is the delay amount included in the target arbitrary sound field characteristic (P), “DH” is the delay amount by the adaptive filter (H), and “DC” is the delay amount by the reproduction sound field characteristic (C). When the auxiliary filter (S) is converged to “0”, from the “auxiliary filter definition equation” in FIG. 6, “0=P−HC”, and “P=HC”. A relationship of the delay amount in respective filters becomes “DP=DH+DC”, and by transforming this, “DH=DP−DC”. From such a relationship, the delay amount of the adaptive filter (H) includes the delay amount (DP) of the arbitrary sound field characteristic (P) that can be set by a user and the delay amount (DC) of the reproduction sound field characteristic (C). Therefore, the user need not think of the “DC”, and the delay amount of the adaptive filter (H) follows “DC”, and as understood from the above equations, because the maximum value of the delay amount is limited, it is understood that there is no buildup of the delay amount.

Thus, in the adaptive-filter calculating device of the first embodiment, the output stage of the arbitrary sound field characteristic (P) is incorporated in parallel in the inverse system, and after the simple delay is set to the arbitrary sound field characteristic (P), the adaptive filter (H) is updated, designating the arbitrary sound field characteristic (P) as a target, to thereby compensate for the delay amount present in the actual system. In the update of the adaptive filter (H), the delay amount is fixed by the simple delay set in the (P), and thus there is no buildup of the delay amount.

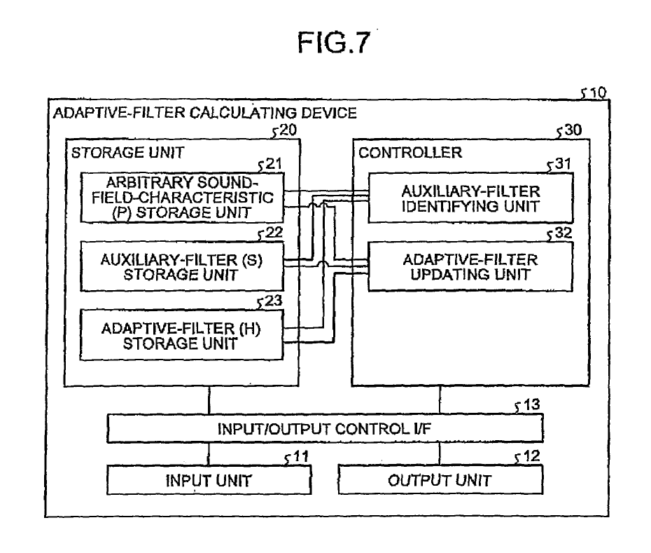

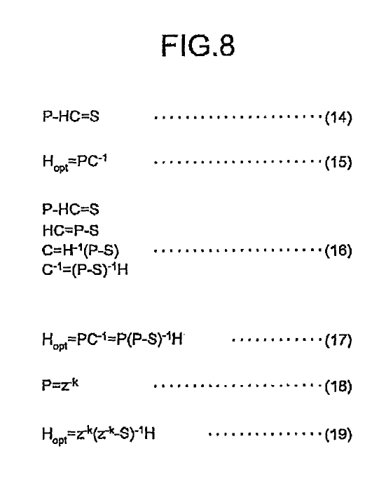

The adaptive-filter calculating device according to the first embodiment will be described with reference to FIGS. 7 and 8. FIG. 7 is a block diagram of the configuration of the adaptive-filter calculating device according to the first embodiment. FIG. 8 depicts computational expressions in the adaptive-filter calculating device.

As shown in FIG. 7, an adaptive-filter calculating device 10 of the first embodiment includes an input unit 11, an output unit 12, an input/output control interface (I/F) 13, a storage unit 20, and a controller 30.

The input unit 11 inputs data to be used for various processing by the controller 30, an operation instruction for performing various processing, and the like by communication or the like by a device as a sound source, a microphone, a keyboard, a mouse, a storage medium, or a communication unit (not shown).

Specifically, the input unit 11 receives an input of the input signal (X), which is an adaptive filter calculation target in the adaptive-filter calculating device 10 by the device as the sound source or the like, and inputs the input signal (X) to the adaptive-filter calculating device 10. The input unit 11 further receives an input of the reproduction sound field characteristic (C) at the time of calculating the adaptive filter by the microphone or the like, and inputs the reproduction sound field characteristic (C) to the adaptive-filter calculating device 10. Further, the input unit 11 receives an input of a value of the arbitrary sound field characteristic (P) set by the user who uses the adaptive-filter calculating device 10, and an input of the initial value of the adaptive filter (H) by the keyboard or the like, and inputs the values to the adaptive-filter calculating device 10.

The output unit 12 outputs results of the various processing by the controller 30, the operation instruction for performing the various processing, and the like to a speaker, a monitor, or a printer. Specifically, the output unit 12 outputs the adaptive filter (H) updated by an adaptive-filter updating unit 32 described later to the monitor.

The input/output control I/F 13 controls data transfer between the input unit 11 and the output unit 12, and between the storage unit 20 and the controller 30.

The storage unit 20 stores data for use in various processing by the controller 30, and as shown in FIG. 7, includes an arbitrary sound-field-characteristic storage unit 21, an auxiliary-filter storage unit 22, and an adaptive-filter storage unit 23.

The arbitrary sound-field-characteristic storage unit 21 stores the arbitrary sound field characteristic (P). Specifically, the arbitrary sound-field-characteristic storage unit 21 stores the arbitrary sound field characteristic (P) input by the input unit 11, and the stored arbitrary sound field characteristic (P) is used for the processing by an auxiliary-filter identifying unit 31 and the adaptive-filter updating unit 32 described later. For example, the arbitrary sound-field-characteristic storage unit 21 stores the simple delay as the arbitrary sound field characteristic (P).

The auxiliary-filter storage unit 22 stores the auxiliary filter (S). Specifically, the auxiliary-filter storage unit 22 stores the auxiliary filter (S) in a process of being identified by the auxiliary-filter identifying unit 31 and the identified auxiliary filter (S), and the stored auxiliary filter (S) is used for the processing by the adaptive-filter updating unit 32. In the first embodiment, for the adaptive-filter calculating device 10, a method is explained in which the initial value of the auxiliary filter (S) is not particularly set. However, this is given by way of example only, and the initial value of the auxiliary filter (S) may be appropriately set and stored in the auxiliary-filter storage unit 22.

The adaptive-filter storage unit 23 stores the adaptive filter (H). Specifically, the adaptive-filter storage unit 23 stores the initial value of the adaptive filter (R) input by the input unit 11 and the adaptive filter (H) updated by the adaptive-filter updating unit 32, and the stored adaptive filter (H) is used for the processing by the auxiliary-filter identifying unit 31 and the adaptive-filter updating unit 32. For example, the adaptive-filter storage unit 23 stores the initial value shown in equation (10) in FIG. 4.

The controller 30 performs various processing by controlling the adaptive-filter calculating device 10, and includes the auxiliary-filter identifying unit 31 and the adaptive-filter updating unit 32, as shown in FIG. 7.

The auxiliary-filter identifying unit 31 uses the adaptive filter (H) with the initial value set thereto or the updated adaptive filter (H) to determine or identify the auxiliary filter (S), designating the arbitrary sound field characteristic (P) as the target. Specifically, the auxiliary-filter identifying unit 31 uses the input signal (X) input by the input unit 11, the reproduction sound field characteristic (C) input by the input unit 11, the arbitrary sound field characteristic (P) stored by the arbitrary sound-field-characteristic storage unit 21, and the initial value of the adaptive filter (H) stored by the adaptive-filter storage unit 23, to determine or identify the auxiliary filter (S) so that the error (E) becomes “0” in the “estimated error definition equation” shown in FIG. 6 (for example, identify the auxiliary filter (S) by using an NLMS method or a learning identification method), and the identified auxiliary filter (S) is stored in the auxiliary-filter storage unit 22.

The “estimated error definition equation” shown in FIG. 6 will be explained. First, in the actual system, the input signal (X) having passed through the adaptive filter (H) and the reproduction sound field characteristic (C) is affected by the delay without question. Therefore, the delay amount is included in the input signal (X) having passed through the adaptive filter (H) and the reproduction sound field characteristic (C). On the other hand, the adaptive-filter calculating device 10 of the first embodiment also sets a fixed value as the simple delay for the arbitrary sound field characteristic (P) incorporated in parallel therewith, thereby including the delay amount therein.

The arbitrary sound field characteristic (P) incorporated in parallel therewith is the arbitrary sound field characteristic, which becomes a target upon identifying the auxiliary filter (S). That is, the adaptive-filter calculating device 10 updates the adaptive filter (H) so that the input signal (X) having passed through the adaptive filter (H) and the reproduction sound field characteristic (C) becomes equal to the input signal (X) having passed through the arbitrary sound field characteristic (P). In other words, the auxiliary-filter identifying unit 31 identifies the auxiliary filter (S) in the “estimated error definition equation” in FIG. 6 to be “0”.

It is assumed herein that “DP” is the delay amount included in the target arbitrary sound field characteristic (P), “DH” is the delay amount by the adaptive filter (H), and “DC” is the delay amount by the reproduction sound field characteristic (C). When the auxiliary filter (S) is converged to “0”, from the “auxiliary filter definition equation” in FIG. 6, “0=P−HC”, and “P=HC”. The relationship of the delay amount in each filter becomes “DP=DH+DC”, and by transforming this, “DH=DP−DC”. From such a relationship, the delay amount of the adaptive filter (H) includes the delay amount (DP) of the arbitrary sound field characteristic (P) that can be set by the user and the delay amount (DC) of the reproduction sound field characteristic (C). Therefore, the user need not think of the “DC”, and the delay amount of the adaptive filter (H) follows “DC”, and as understood from the above equations, because the maximum value of the delay amount is limited, it is understood that there is no buildup of the delay amount.

The adaptive-filter updating unit 32 uses the identified auxiliary filter (S) to update the adaptive filter (H). Specifically, the adaptive-filter updating unit 32 uses the auxiliary filter (S) identified by the auxiliary-filter identifying unit 31 and the arbitrary sound field characteristic (P) stored in-the arbitrary sound-field-characteristic storage unit 21 to update the adaptive filter (H) according to the “adaptive filter update equation” shown in FIG. 6, and the updated adaptive filter (H) is stored in the adaptive-filter storage unit 23.

The “adaptive filter update equation” is explained with reference to FIG. 8. First, equation (14) is for defining a relationship between the arbitrary sound field characteristic (P), the adaptive filter (H), the reproduction sound field characteristic (C), and the auxiliary filter (S), as in the “auxiliary filter definition equation” in FIG. 6. The arbitrary sound field characteristic (P) is the sound field characteristic designated as the target by the adaptive-filter calculating device 10. Therefore; the adaptive filter (H) should be updated so that HC=P. That is, when the adaptive filter (H) is in an optimum state, the output signal (Y) should be equal to the output signal having passed through the arbitrary sound field characteristic (P). Accordingly, the auxiliary-filter identifying unit 31 identifies the auxiliary filter (S) to be “0”. At this time, the optimum adaptive filter (H) is expressed by equation (15).

Because equation (14) is transformed as shown in equation (16), the update equation of the optimum adaptive filter becomes equation (17), by using a known filter (the auxiliary filter (S)). That is, the adaptive-filter updating unit 32 updates the adaptive filter (H) by using equation (17).

In the adaptive-filter calculating device 10 of the first embodiment, the simple delay is set in the arbitrary sound field characteristic (P). That is, because the arbitrary sound field characteristic (P) incorporated in parallel is set as in equation (18), the adaptive-filter updating unit 32 updates the adaptive filter (H) by using the delay amount k as a target. If the delay amount k is sufficiently large, the system can repetitively execute the adaptive processing without requiring the delay amount larger than this.

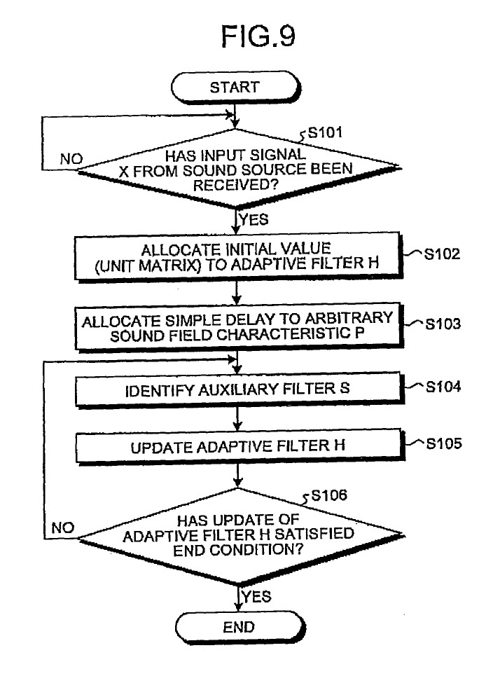

The process procedure performed by the adaptive-filter calculating device 10 according to the first embodiment is explained next with reference to FIG. 9. FIG. 9 is a flowchart of the process procedure performed by the adaptive-filter calculating device according to the first embodiment.

The adaptive-filter calculating device 10 determines whether the input signal (X) from the sound source has been received (Step S101). When the input signal (X) has been received (YES at Step S101), the auxiliary-filter identifying unit 31 reads the initial value of the adaptive filter (H) stored in the adaptive-filter storage unit 23 and allocates a unit matrix to the adaptive filter (H) in the estimated error definition equation (Step S102).

Subsequently, the auxiliary-filter identifying unit 31 reads the arbitrary sound field characteristics (P) stored in the arbitrary sound-field-characteristic storage unit 21 and allocates a simple delay to the arbitrary sound field characteristic (P) in the estimated error definition equation (Step S103).

The auxiliary-filter identifying unit 31 then determines or identifies the auxiliary filter (S) (Step S104). Specifically, the auxiliary-filter identifying unit 31 uses the input signal (X) input by the input unit 11, the reproduction sound field characteristic (C) input by the input unit 11, the arbitrary sound field characteristic (P) with the simple delay being allocated, and the adaptive filter (H) with the unit matrix being allocated, to determine or identify the auxiliary filter (S) so that the error (E) becomes “0” in the “estimated error definition equation” shown in FIG. 6, and the identified auxiliary filter (S) is stored in the auxiliary-filter storage unit 22.

The adaptive-filter updating unit 32 then updates the adaptive filter (H) (Step S105). Specifically, the adaptive-filter updating unit 32 uses the known arbitrary sound field characteristic (P) and the auxiliary filter (S), which is known by being identified at Step S104, to update the adaptive filter (H) according to the “adaptive filter update equation” shown in FIG. 6, and the updated adaptive filter (H) is stored in the adaptive-filter storage unit 23.

Thereafter, the adaptive-filter calculating device 10 determines whether update of the adaptive filter (H) satisfies an end condition (Step S106). Specifically, the adaptive-filter calculating device 10 determines whether the end condition is satisfied, designating that the input signal (X) is not present or suspension of the adaptive filter update processing is instructed by the user (input of a suspension command) as the end condition.

As a result of the determination at Step S106, when update of the adaptive filter (H) does not satisfy the end condition (NO at Step S106), the adaptive-filter calculating device 10 returns to the identification process of the auxiliary filter (S) by the auxiliary-filter identifying unit 31 (Step S104) to repeat the process at Steps S104 and S105.

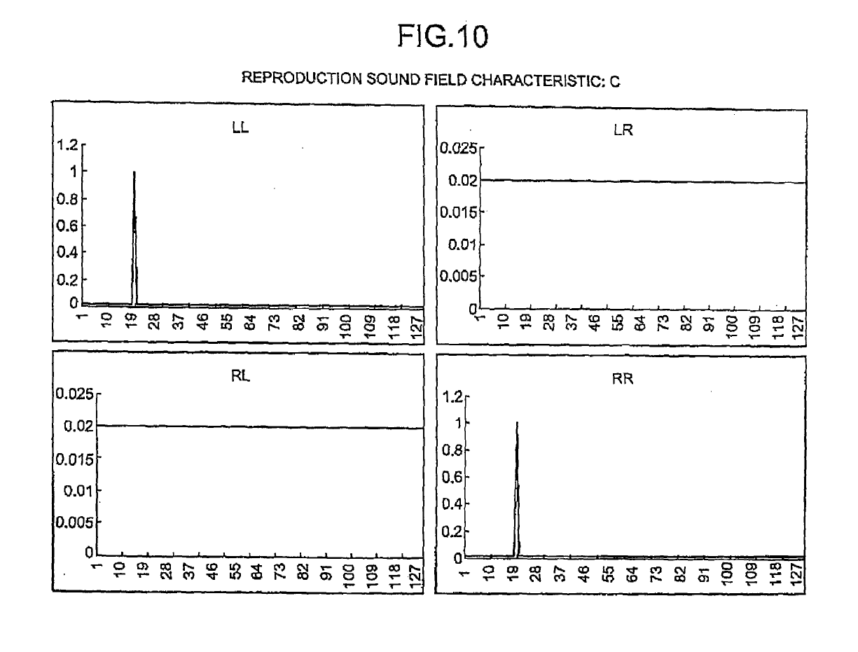

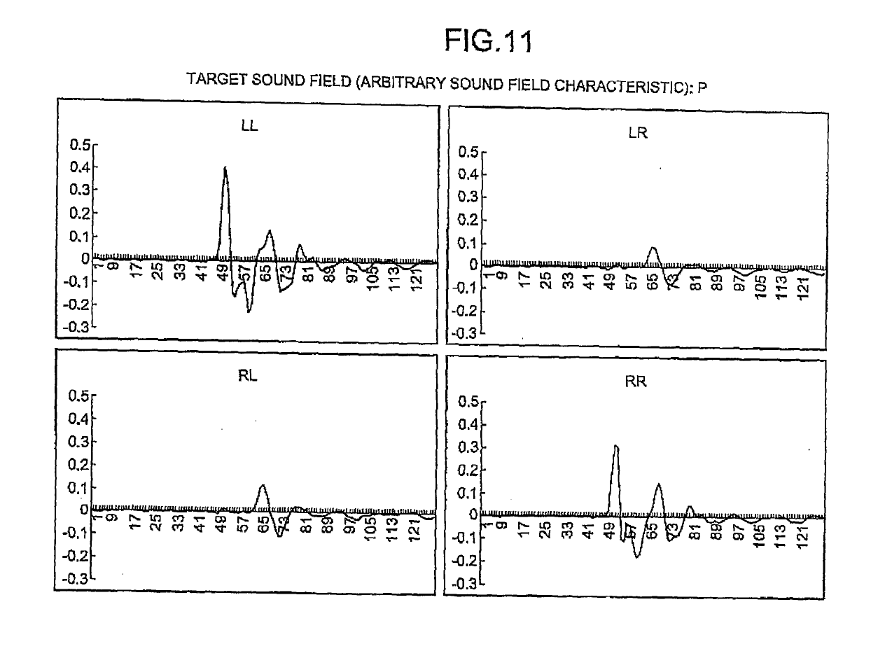

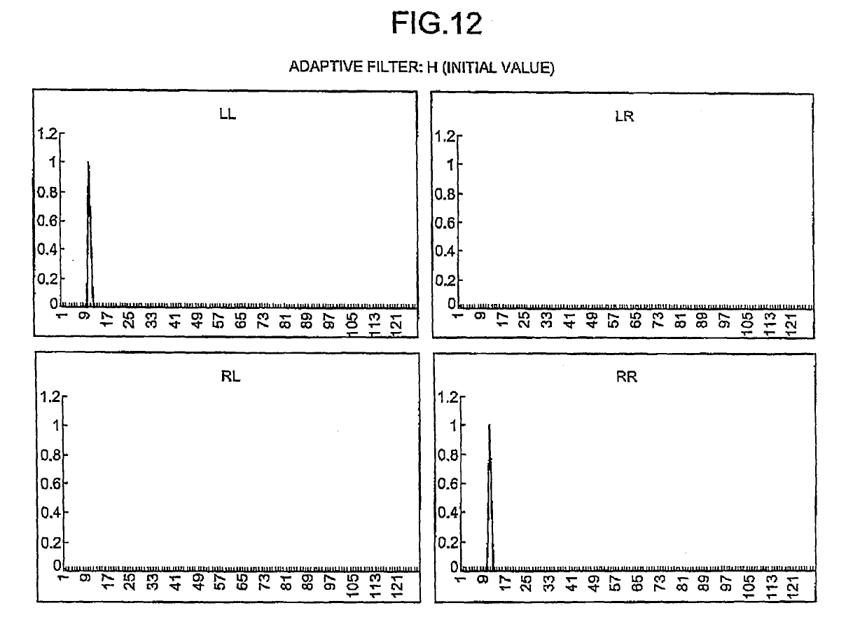

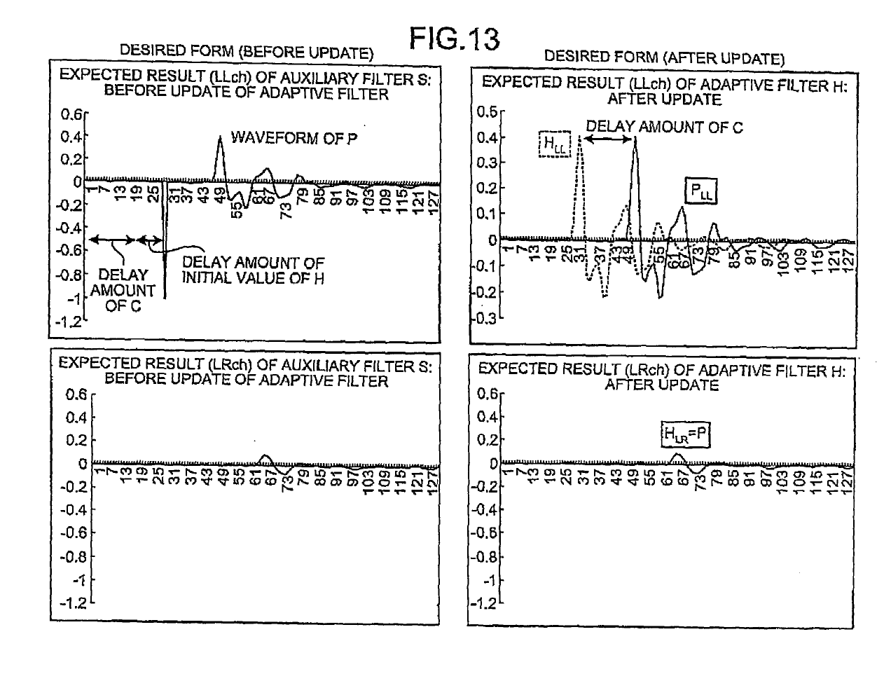

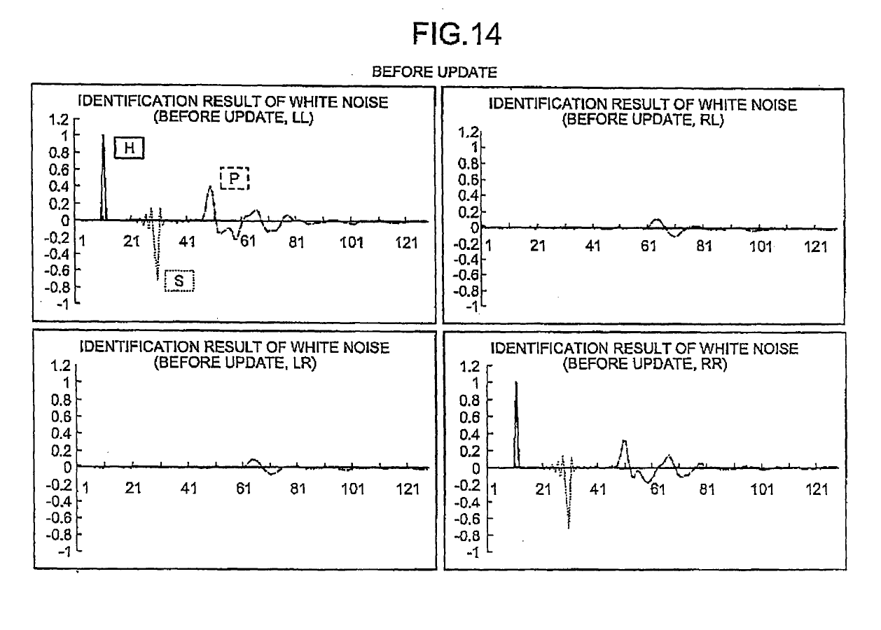

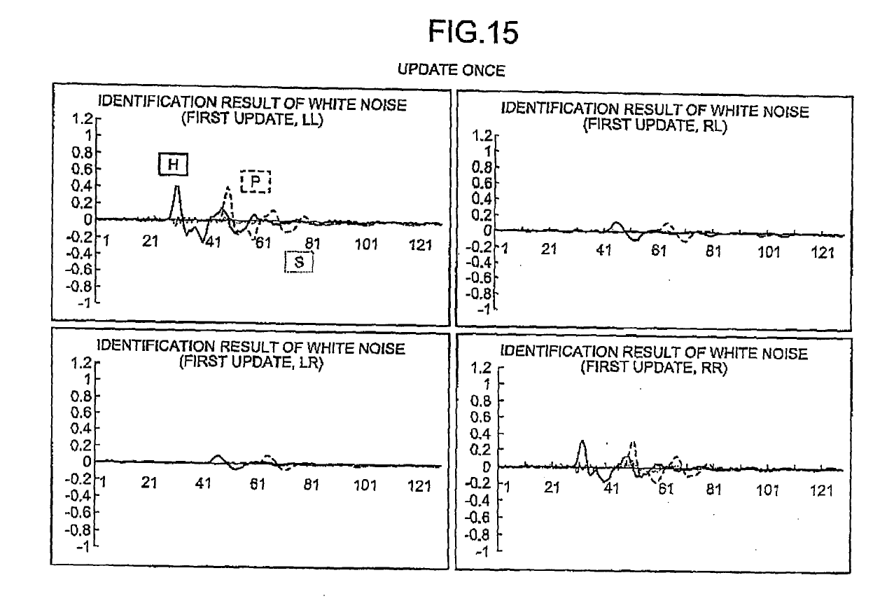

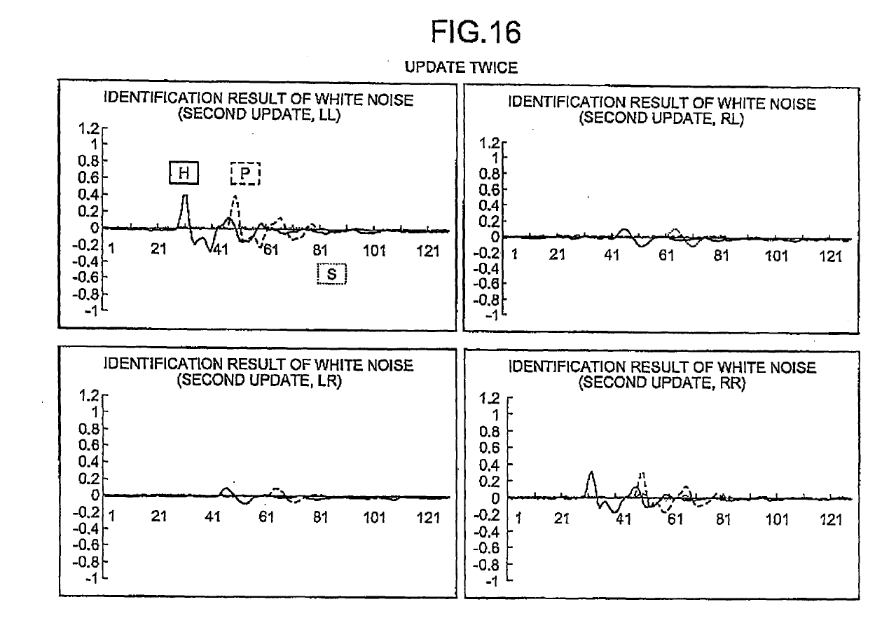

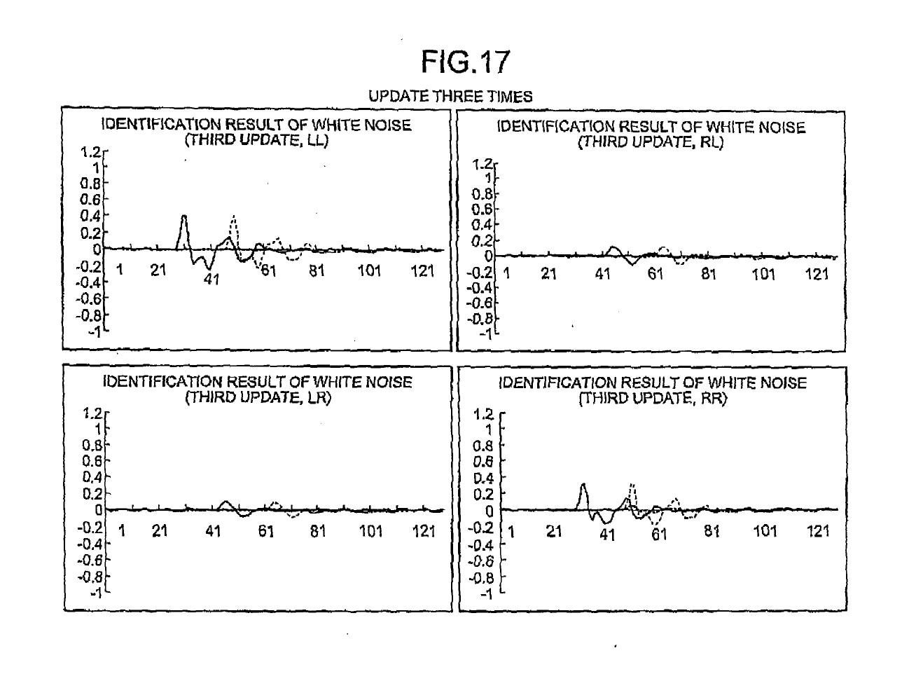

A simulation result by the adaptive-filter calculating device according to the first embodiment will be described with reference to FIGS. 10 to 17. FIG. 10 depicts charts for explaining a simulation condition of the reproduction sound field characteristic (C). FIG. 11 depicts charts for explaining a simulation condition of the arbitrary sound field characteristic (P). FIG. 12 depicts charts for explaining a simulation condition of the adaptive filter (H). FIG. 13 depicts charts for explaining a desired form of simulation. FIG. 14 depicts charts for explaining a state before update. FIG. 15 depicts charts for explaining first update. FIG. 16 depicts charts for explaining second update. FIG. 17 depicts charts for explaining third update.

In the present simulation, the reproduction sound field characteristic (C) is provided as shown in FIG. 10. That is, the reproduction sound field characteristic (C) should be essentially provided in some waveform. However, the simulation does not aim at verifying that the adaptive filter (H) has the inverse characteristic, but aims at verifying that the-updated adaptive filter (H) does not exceed the delay amount of the arbitrary sound field characteristic (P). Therefore, the unit matrix is provided to the reproduction sound field characteristic (C). As shown in FIG. 10, the delay amount for 20 samples is provided to the reproduction sound field characteristic (C).

Further, in the simulation, the targeted arbitrary sound field characteristic (P) is provided as shown in FIG. 11. Further, for the initial value of the adaptive filter (H), the unit matrix is provided as shown in FIG. 12, and a delay amount for ten samples is provided.

Two charts on the left in FIG. 13 indicate expected results (desired states) of the auxiliary filter (S) before the update of the adaptive filter (H), and two charts on the right indicate expected results (desired states) of the adaptive filter (H) after the update of the adaptive filter (H). That is, as understood from the expected result (upper chart) of the auxiliary filter (S), because the auxiliary filter (S) is “P−HC”, the waveforms of “C” in FIG. 10 and “H” in FIG. 12 are shown in a state delayed for 30 samples with respect to the waveform of “P” in FIG. 11 as negative (−) values (in a state that the delay amount of the reproduction sound field characteristic (C) for 20 samples and the delay amount of the adaptive filter (H) for ten samples are added). Further, as understood from the expected result (upper chart) of the adaptive filter (H), the updated adaptive filter (H) does not exceed the delay amount of the arbitrary sound field characteristic (P).

When studying the actual simulation results, as understood from sequential reference to FIGS. 14 to 17, the auxiliary filter (S) is identified so that it gradually becomes “0”. On the other hand, the adaptive filter (H) is updated with the arbitrary sound field characteristic (P) as the target, however, the delay amount is kept constant (note that a gap between the adaptive filter (H) and the arbitrary sound field characteristic (P) is kept constant in every chart in FIGS. 15 to 17)

As described above, according to the first embodiment, the auxiliary filter is identified with the arbitrary sound field characteristic being set as the target by using the adaptive filter with the initial value being set or the updated adaptive filter with respect to the inverse system in which the adaptive filter having the inverse characteristic of the reproduction sound field characteristic, which is the sound field characteristic of the environment where the sound source as the input signal is reproduced, is serially incorporated in the previous stage of the output stage of the reproduction sound field characteristic, and the auxiliary filter for updating the adaptive filter and the output stage of the arbitrary sound field characteristic are incorporated in parallel. When the auxiliary filter is identified, the adaptive filter is updated by using the identified auxiliary filter. As a result, the adaptive filter that appropriately reproduces the sound can be calculated.

Further, by obtaining the inverse system that follows fluctuation of a sound field, it is possible to hear higher fidelity original sound.

The adaptive-filter calculating device to which is applied the adaptive filter calculation method has been explained 80 far in the first embodiment. Such an adaptive filter calculation method can be applied, for example, to a system that controls an audio image of a seat speaker provided at rear seats (backseats) of a vehicle (or referred to as a location system). In the second embodiment, a sound field generating device applying to which is applied the adaptive filter calculation method is explained below.

As explained in the first embodiment, the adaptive-filter calculating device updates the adaptive filter (H) so that the auxiliary filter (S) becomes “0”. That is, it means that the output signal (Y) having passed through the sound field characteristic on the reproduction side approaches the set arbitrary sound field characteristic (P) as the target. Therefore, if the auxiliary filter method is used, the system can reproduce the sound field only by setting the sound field characteristic (Q) desired to be reproduced as the arbitrary sound field characteristic (P) (at this time, an appropriate delay amount needs to be provided to the sound field characteristic desired to be reproduced). Accordingly, the sound field generating device according to the second embodiment sets the sound field characteristic (Q) desired to be reproduced as the arbitrary sound field characteristic (P).

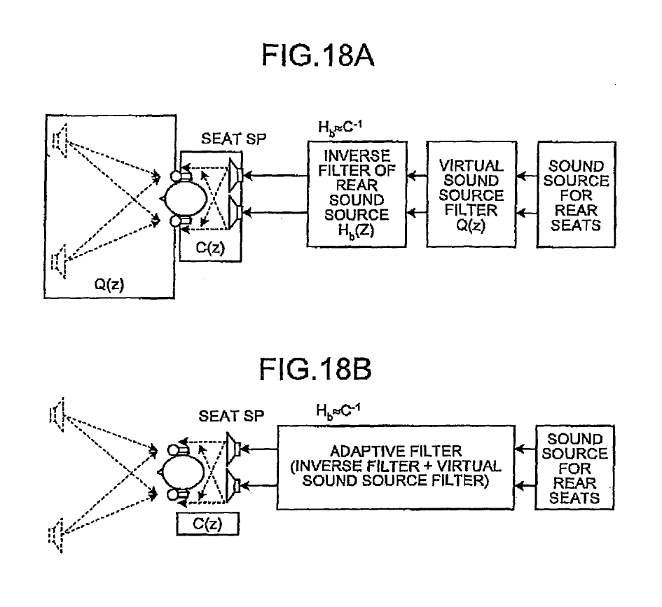

FIGS. 18A and 18B are schematic diagrams for explaining the outline and the characteristics of the sound field generating device of the second embodiment. FIG. 18A depicts a configuration when the sound field generating device of the second embodiment is not used. A “sound source for rear seats” corresponds to the sound source, an “inverse filter H_{b} (z) of rear sound source” corresponds to the adaptive filter (H), and “C(z)” from the seat speaker (seat SP) to ears corresponds to the reproduction sound field characteristic (C). As shown in FIG. 18A, a “virtual sound source filter Q(z)” is incorporated between the sound source and the adaptive filter (H). Because the adaptive filter (H) has the inverse characteristic of the reproduction sound field characteristic (C), the reproduction sound field characteristic (C) is negated. That is, in this system, the reproduction sound field characteristic (C) from the seat speaker to the ears is eliminated. As explained in the first embodiment, however, in such a configuration, the sound cannot be appropriately reproduced (the problem of increase of the delay amount cannot be solved).

On the other hand, FIG. 18B depicts a configuration when the sound field generating device of the second embodiment is used. The “sound source for rear seats” corresponds to the sound source, an “adaptive filter (inverse filter+virtual sound source filter)” corresponds to the adaptive filter (H), and “C(z)” from the seat speaker (seat SP) to the ears corresponds to the reproduction sound field characteristic (C). Because the adaptive filter (H) has inverse characteristic of the reproduction sound field characteristic (C), the reproduction sound field characteristic (C) is negated. Further, because the adaptive filter (H) is updated by designating the virtual sound source filter (Q) as the target, the adaptive filter (H) also has the sound field characteristic of the virtual sound source filter (Q). That is, in such a system, not only the reproduction sound field characteristic (C) from the seat speaker to the ears is eliminated, but also an output signal superposed with the sound field characteristic of the virtual sound source filter (Q) reaches the ears. That is, the reproduced audio image is expanded forward virtually.

To explain specifically, in the sound field generating device of the second embodiment, as shown in FIG. 6, as in the adaptive-filter calculating device of the first embodiment, the output stage of the arbitrary sound field characteristic (P) is incorporated in parallel. In the second embodiment, the virtual sound source filter (Q) is provided to the arbitrary sound field characteristic (P). An appropriate delay amount is provided to the virtual sound source filter (Q).

In such a sound field generating device, as in the first embodiment, the auxiliary filter (S) is defined by the “auxiliary filter definition equation” shown in FIG. 6. Further, the sound field generating device needs only to update the adaptive filter (H) according to the “adaptive filter update equation”. That is, the sound field generating device updates the adaptive filter (H) according to an update equation indicated by the arbitrary sound field characteristic (P) and the auxiliary filter (S) identified according to the arbitrary sound field characteristic (P) as the target, thereby updating the arbitrary sound field characteristic (P) as the target.

Thus, the sound field generating device of the second embodiment updates the adaptive filter (H), using the virtual sound source filter (Q) provided with an appropriate delay as the target. Therefore, the delay amount does not continuously increase every time the adaptive filter (H) is updated, and the virtual sound source can be realized, thereby enabling to reproduce the sound appropriately.

In the second embodiment, an example is described in which the virtual sound source is realized, while the reproduction sound field characteristic (C) from the seat speaker to the ears is eliminated by setting the virtual sound source filter (Q) in the arbitrary sound field characteristic (P). However, only the reproduction sound field characteristic (C) from the seat speaker to the ears may be eliminated by setting the simple delay in the arbitrary sound field characteristic (P).

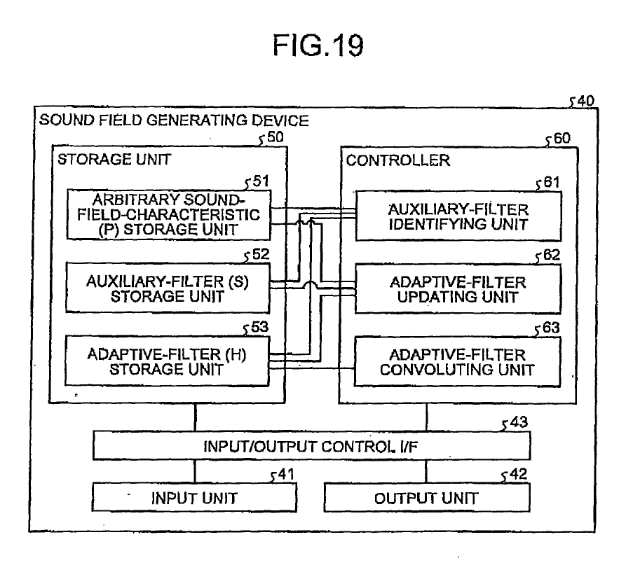

The sound field generating device of the second embodiment will be described with reference to FIG. 19. FIG. 19 is a block diagram of a sound field generating device 40 according to the second embodiment. As depicted in FIG. 19, the sound field generating device 40 includes a storage unit 50, a controller 60, an input/output control I/F 43, an input unit 41, and an output unit 42. The storage unit 50 includes an arbitrary sound-field-characteristic storage unit 51, an auxiliary-filter storage unit 52, and an adaptive-filter storage unit 53. The controller 60 includes an auxiliary-filter identifying unit 61, an adaptive-filter updating unit 62, and an adaptive-filter convoluting unit 63.

As understood from the comparison between FIGS. 19 and 7, the sound field generating device 40 of the second embodiment is different from the adaptive-filter calculating device 10 of the first embodiment in that the adaptive-filter convoluting unit 63 is added.

The adaptive-filter convoluting unit 63 superposes the updated adaptive filter (H) on the reproduction sound field characteristic (C). Specifically, when the update by the adaptive-filter updating unit 62 satisfies a predetermined end condition, the adaptive-filter convoluting unit 63 superposes the updated adaptive filter (H) on the reproduction sound field characteristic (C), and outputs a superposed output signal (Y) to the output unit 42 (speaker or the like).

In the second embodiment, the arbitrary sound-field-characteristic storage unit 51 stores the virtual sound source filter (Q) provided with an appropriate delay as the arbitrary sound field characteristic (P). The term “virtual sound source” as used herein refers to a sound source in which a sense of direction, a sense of resonance, tone, frequency characteristic, and the like of the sound are defined.

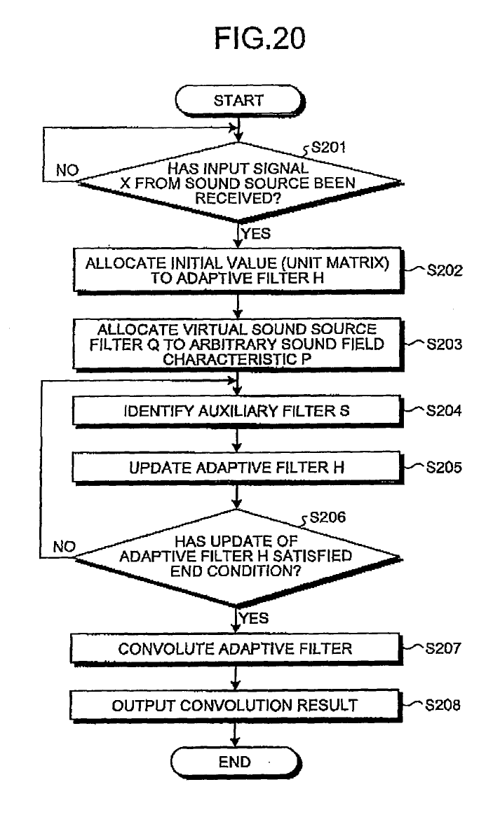

A process procedure performed by the sound field generating device 40 according to the second embodiment will be described with reference to FIG. 20. FIG. 20 is a flowchart of a process procedure performed by the sound field generating device 40 according to the second embodiment.

As understood from the comparison between FIG. 9 and FIG. 20, the process procedure performed by the sound field generating device 40 of the second embodiment is different from that of the adaptive-filter calculating device 10 of the first embodiment in that Steps S207 and S208 are added.

Specifically, the sound field generating device 40 of the second embodiment determines whether the input signal (X) from the sound source has been received (Step S201), as in the first embodiment. When the input signal (X) has been received (YES at Step S201), the auxiliary-filter identifying unit 61 allocates a unit matrix to the adaptive filter (H) in the estimated error definition equation (Step S202).

Subsequently, the auxiliary-filter identifying unit 61 allocates the virtual sound source filter (Q) added with an appropriate delay to the arbitrary sound field characteristic (P) in the estimated error definition equation (Step S203), different from the first embodiment.

As in the first embodiment, the auxiliary-filter identifying unit 61 identifies the auxiliary filter (S) (Step S204), and the adaptive-filter updating unit 62 updates the adaptive filter (H) (Step S205). Thereafter, the sound field generating device 40 determines whether update of the adaptive filter (H) satisfies the end condition (Step S206). As a result of determination, it the update of the adaptive filter (H) does not satisfy the end condition (NO at Step S206), the sound field generating device 40 returns to the process of identifying the auxiliary filter (S) by the auxiliary-filter identifying unit 61 (Step S204) to repeat the process at Steps S204 and S205.

On the other hand, as a result of determination, if the update of the adaptive filter (H) satisfies the end condition (YES at Step S206), the sound field generating device 40 convolutes the adaptive filter (H) stored in the adaptive-filter storage unit 53 (updated adaptive filter (H)) in the reproduction sound field characteristic (C) (Step S207), and outputs a convolution result to the output unit 42 such as the speaker (Step S208).

As described above, according to the second embodiment, for an inverse system including an adaptive filter that has an inverse characteristic of a reproduction sound field characteristic, which is a sound field characteristic of an environment where a sound source as an input signal is reproduced, and that is arranged in series with a stage previous to an output stage of the reproduction sound field characteristic, and an auxiliary filter that updates the adaptive filter and that is arranged in parallel with an output stage of an arbitrary sound field characteristic, the auxiliary filter is identified based on the arbitrary sound field characteristic as a target by using the adaptive filter with an initial value set thereto or the adaptive filter having been updated. When the auxiliary filter is identified, the adaptive filter is updated by using the identified auxiliary filter, and when the update satisfies the predetermined end condition, the updated adaptive filter is superposed on the reproduction sound field characteristic. As a result, the sound can be appropriately reproduced.

Further, because of the arbitrary sound field characteristic in which the virtual sound field characteristic is set, the sound field characteristic desired to be reproduced can be appropriately reproduced. For example, a content producer (music production engineer) can add sound effects to a music source beforehand.

In the first and second embodiments, it is assumed by way of example, and without intending to be restrictive, that the adaptive filter is of finite impulse responses (FIR) type; however, it may be an adaptive lattice filter or the like.

Further, in the first and second embodiments, the, normalized LMS (NLMS) method is used for the identification algorithm of the auxiliary filter. However, this is presented by way of example only, and other methods such as the learning identification method may be used.

Of the processes described above, all or part of the processes explained as being performed automatically can be performed manually, or all or part of the processes explained as being performed manually can be performed automatically by a known method. The process procedures (FIGS. 9, 20 or the Like), control procedures, specific names, and information including various kinds of data and parameters described herein and in the drawings can be arbitrarily changed unless otherwise specified.

The constituent elements of the apparatus shown in the drawings are functionally conceptual, and need not be physically configured as illustrated (FIG. 7, for example). That is, the specific mode of dispersion and integration of the constituent elements is not limited to the ones illustrated in the drawings, and the constituent elements, as a whole or in part, can be separated or integrated either functionally or physically based on various types of loads or use conditions. In addition, all or part of various processing functions performed by the respective devices may be realized by a central processing unit (CPU) or a program analyzed and executed by the CPU, or may be realized as hardware by wired logic.

A computer program prepared in advance may be executed on a computer, such as a personal computer or a workstation, to implement the adaptive filter calculation method and the sound field generation method explained in the first and second embodiments. Such a computer program may be distributed via a network such as the Internet. The computer program may be stored in a computer readable recording medium such as hard disk, flexible disk (FD), compact disk-read only memory (CD-ROM), magneto optical (MO), or digital versatile disk (DVD), and read therefrom to be executed on a computer.

Although the invention has been described with respect to specific embodiments for a complete and clear disclosure the appended claims are not to be thus limited but are to he construed as embodying all modifications and alternative constructions that may occur to one skilled in the art that fairly fall within the basic teaching herein set forth.

What is claimed is;

1. An adaptive filter calculation method comprising:
identifying an auxiliary filter for an inverse system including an adaptive filter that has an inverse characteristic of a reproduction sound field characteristic, which is a sound field characteristic of an environment where a sound source as an input signal is reproduced, and that is arranged in series with a stage previous to an output stage of the reproduction sound field characteristic, and the auxiliary filter that updates the adaptive filter and that is arranged in parallel with an output stage of an arbitrary sound field characteristic, wherein the auxiliary filter is identified based on the arbitrary sound field characteristic as a target using either the adaptive filter with an initial value set therein or the adaptive filter having been updated; and
updating the adaptive filter using the auxiliary filter identified at the identifying.

2. A sound field generating device comprising:
an identifying unit that identifies an auxiliary filter for an inverse system including an adaptive filter that has an inverse characteristic of a reproduction sound field characteristic, which is a sound field characteristic of an environment where a sound source as an input signal is reproduced, and that is arranged in series with a stage previous to an output stage of the reproduction sound field characteristic, and the auxiliary filter that updates the adaptive filter and that is arranged in parallel with an output stage of an arbitrary sound field characteristic, the identifying unit being configured to identify the auxiliary filter based on the arbitrary sound field characteristic as a target using either the adaptive filter with an initial value-set therein or the adaptive filter having been updated;
an updating unit that updates the adaptive filter using the auxiliary filter identified by the identifying unit; and
an adaptive-filter superposing unit that, when update of the adaptive filter satisfies a predetermined end condition, superposes the adaptive filter updated by the updating unit on the reproduction sound field characteristic.

3. The sound field generating device according to claim 2, wherein the identifying unit identifies the auxiliary filter for the inverse system having the arbitrary sound field characteristic with a simple delay set therein.

4. The sound field generating-device according to claim 2, wherein the identifying unit identifies the auxiliary filter for the inverse system having the arbitrary sound field characteristic with a virtual sound field characteristic set therein.
